(19) United States
(12) Patent Application Publication
(10) Pub. No.: US 2004/0018389 A1
(43) Pub. Date: Jan. 29, 2004

(54) Perpendicular magnetic recording media

(75) Inventors: Byung-Kyu Lee, Seoul (KR); Hoon-Sang Oh, Seoul (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/463,472

(22) Filed: Jun. 18, 2003

(30) Foreign Application Priority Data
Jul. 27, 2002 (KR) 2002-44463

(51) Int. Cl. B32B 3/00

(52) U.S. Cl. 428/694 MM; 428/694 T; 428/694 R

(57) ABSTRACT

A perpendicular magnetic recording medium in which a perpendicular magnetic recording layer is placed over a substrate and a soft magnetic layer is placed between the substrate and the perpendicular magnetic recording layer. In the perpendicular magnetic recording medium, a soft magnetic orientation layer placed between the soft magnetic layer and the substrate to magnetically orient the soft magnetic layer. Thus, although the soft magnetic layer is thin, it still has stable magnetic properties and generates less noise.

### BACKGROUND OF THE INVENTION

This application claims the priority of Korean Patent Application No. 2002-44463, filed on Jul. 27, 2002, in the Korean Intellectual Property Office, the disclosure of which is incorporated herein in its entirety by reference.

1. Field of the Invention

The present invention relates to perpendicular magnetic recording media, and more particularly, to a perpendicular magnetic recording medium with an increased recording density.

2. Description of the Related Art

Generally, perpendicular magnetic recording mechanisms, as compared with longitudinal magnetic recording mechanisms, represent one possible alternative of extending magnetic recording density. Recently, hard disk drives (HDDs) use perpendicular magnetic recording mechanisms to obtain a high recording density. Perpendicular magnetic recording mechanisms have a magnetization that is perpendicular to the main plane of a recording medium. Such perpendicular magnetic recording mechanisms adopt both a perpendicular magnetic recording medium with a double magnetic layer and a single pole head. A perpendicular magnetic recording medium with a double magnetic layer is inevitably used because of the magnetic circuit properties of the single pole head. In the perpendicular magnetic recording medium with a double magnetic layer, a soft magnetic layer is positioned under a magnetic recording layer and has a thick thickness. The soft magnetic layer may generate large noise due to its big thickness.

FIGS. 1 and 2 show the layer structures of two conventional types of perpendicular magnetic recording medium with a double magnetic layer.

Referring to FIG. 1, a perpendicular magnetic recording layer 103, where information is recorded, is placed over the upper surface of a substrate 100. A perpendicular orientation underlayer 102 and a soft magnetic layer 101 are placed between the substrate 100 and the perpendicular magnetic recording layer 103. The perpendicular orientation underlayer 102 is used to perpendicularly orient the magnetization of the perpendicular magnetic recording layer 103. A protection layer 104 is placed on the perpendicular magnetic recording layer 103 to protect the perpendicular magnetic recording layer 103. A lubricating layer 105 is formed on the protection layer 104 to reduce abrasion of a magnetic head of an HDD and the protection layer 104 due to collision and sliding of the protection layer 104 and the magnetic head.

Referring to FIG. 2, a perpendicular magnetic recording layer 203, where information is recorded, is placed over the upper surface of a substrate 200. A soft magnetic layer 201 is placed between the substrate 200 and the perpendicular magnetic recording layer 203. A protection layer 204 and a lubricating layer 205 are sequentially formed on the perpendicular magnetic recording layer 203.

The soft magnetic layers 101 and 201 form a magnetic path of a perpendicular magnetic field generated by a single pole head, thus enabling information to be recorded on the perpendicular magnetic recording layers 103 and 203. However, because large noise is generated by the soft magnetic layers 101 and 201 when a recorded pattern is reproduced, a signal-to-noise ratio (SNR) is degraded. Such noise from a soft magnetic layer is generated because the soft magnetic layer is thickly deposited to have a stable soft magnetism enough to form a magnetic path of a single pole head. The noise from the soft magnetic layer is proportional to its thickness.

### SUMMARY OF THE INVENTION

The present invention provides a perpendicular magnetic recording medium with a double magnetic layer, in which a soft magnetic layer is as thin as possible and accordingly generates less noise.

According to an aspect of the present invention, there is provided a perpendicular magnetic recording medium, in which a perpendicular magnetic recording layer is placed over a substrate, a soft magnetic layer is placed between the substrate and the perpendicular magnetic recording layer, and a soft magnetic orientation layer placed between the soft magnetic layer and the substrate to magnetically and crystallographically orient the soft magnetic layer.

According to an embodiment of the present invention, a perpendicular orientation underlayer for perpendicularly orienting the magnetization of the perpendicular magnetic recording layer is placed between the perpendicular magnetic recording layer and the soft magnetic layer. Preferably, the soft magnetic orientation layer is mainly formed of any of Pt, Au, Ag, Pd, Co, and Permalloy.

### BRIEF DESCRIPTION OF THE DRAWINGS

The above and other features and advantages of the present invention will become more apparent by describing in detail exemplary embodiments thereof with reference to the attached drawings in which:

FIG. 1 shows the layer structure of a conventional perpendicular magnetic recording medium with a double magnetic layer;

FIG. 2 shows the layer structure of another conventional perpendicular magnetic recording medium with a double magnetic layer;

FIG. 3 shows the layer structure of a perpendicular magnetic recording medium according to a first embodiment of the present invention;

FIG. 4 shows the layer structure of a perpendicular magnetic recording medium according to a second embodiment of the present invention; and

FIGS. 5 and 6 show magnetic hysteresis loops of a perpendicular magnetic recording medium according to the present invention.

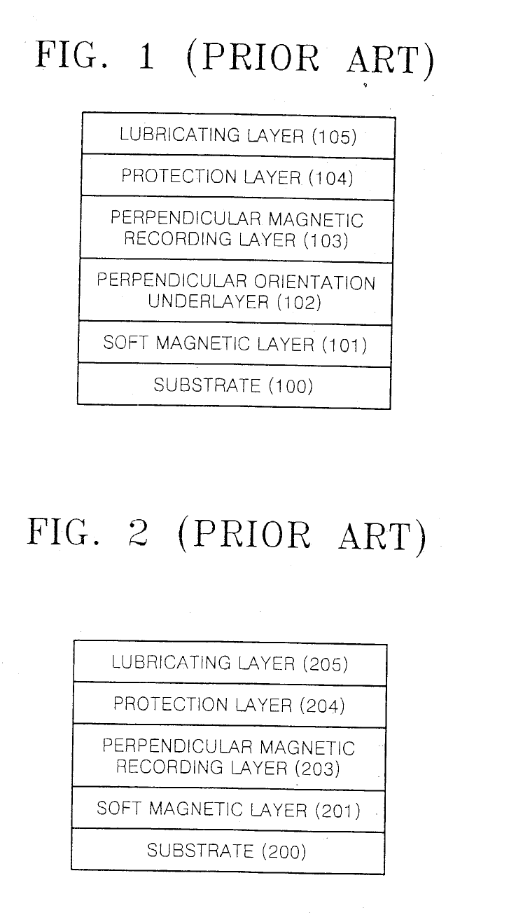

### DETAILED DESCRIPTION OF THE INVENTION

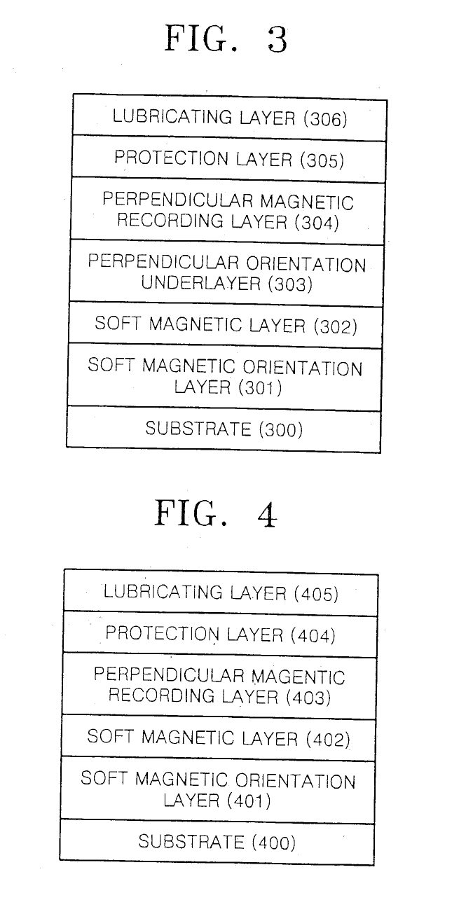

Perpendicular magnetic recording media according to first and second embodiments of the present invention are shown in FIGS. 3 and 4. Referring to FIG. 3, a perpendicular magnetic recording layer 304, where information is recorded, is placed over the upper surface of a substrate 300. A perpendicular orientation underlayer 303 and a soft magnetic layer 302 are placed between the substrate 300 and the perpendicular magnetic recording layer 304. The perpendicular orientation underlayer 303 is used to perpendicularly orient the magnetization of the perpendicular magnetic recording layer 304. A soft magnetic orientation layer 301 for perpendicularly orienting the magnetization of the soft magnetic layer 302 is placed between the soft magnetic layer and the substrate 300. The soft magnetic orientation layer 301 is a characteristic feature of the present invention. A protection layer 305 is placed on the perpendicular magnetic recording layer 304 to protect the perpendicular magnetic recording layer 304. A lubricating layer 306 is placed on the protection layer 305 to reduce abrasion of a magnetic head of an HDD and the protection layer 305 due to collision and sliding of the protection layer 305 and the magnetic head.

Referring to FIG. 4, a perpendicular magnetic recording layer 403, where information is recorded, is placed over the upper surface of a substrate 400. A soft magnetic layer 402 and a soft magnetic orientation layer 401 for perpendicularly orienting the magnetization of the soft magnetic layer 402 are interposed between the substrate 400 and the perpendicular magnetic recording layer 403. The soft magnetic orientation layer 401 is a characteristic feature of the present invention. A protection layer 404 is formed on the perpendicular magnetic recording layer 403 to protect the perpendicular magnetic recording layer 403. A lubricating layer 405 is formed on the protection layer 404 to reduce abrasion of a magnetic head of an HDD and the protection layer 305 due to collision and sliding of the protection layer 404 and the magnetic head.

As described above, the soft magnetic layers 302 and 402 form a magnetic path of a perpendicular magnetic field generated by a single pole head, thus enabling information to be recorded on the perpendicular magnetic recording layers 304 and 403.

The soft magnetic orientation layers 301 and 401 deposited below the soft magnetic layers 302 and 402, respectively, make it possible to minimize the thicknesses of the soft magnetic layers 302 and 402 in addition to providing stable soft magnetisms. Thus, the noises generated by the soft magnetic layers 302 and 402 are reduced.

Soft magnetic layers generally have specific crystal structures. Accordingly, if a soft magnetic layer is deposited on a substrate, it has a thick initial growth layer which is uneven and unstable. Because the initial growth layer is magnetically unstable, the soft magnetic layer having the initial growth layer is not helpful to form a magnetic path of a magnetic field of a single pole head. Hence, a soft magnetic material should be sufficiently thickly deposited to obtain a stable soft magnetic layer. However, the thick soft magnetic layer increases noise generated by a perpendicular magnetic recording media upon information recording/reproduction. According to the present invention, the noise is reduced by decreasing the thickness of a soft magnetic layer. The reduction of the thickness of the soft magnetic layer can be achieved by a soft magnetic orientation layer placed below the soft magnetic layer. That is to say, the noise of a perpendicular magnetic recording medium is reduced by minimizing the thickness of a thick soft magnetic layer. Because a soft magnetic orientation layer having a similar crystal structure to that of a soft magnetic layer is positioned on the soft magnetic layer, the soft magnetic layer can be grown with a stable structure upon deposition on the soft magnetic orientation layer. The soft magnetic orientation layer minimizes the initial growth layer of the soft magnetic layer to obtain a thin soft magnetic layer with an improved crystal structure.

A general soft magnetic layer is mainly deposited using Permalloy or a Permalloy alloy containing an additive. A Permalloy alloy has a face centered cubic (FCC) structure and accordingly forms a thick initial growth layer on a glass substrate. To prevent the thick initial growth layer from being formed, a soft magnetic orientation layer is first deposited using a material having an FCC structure, such as, Pt, on a substrate, and then a Permalloy alloy is deposited on the soft magnetic orientation layer. Hence, an initial growth layer for a soft magnetic layer is very thin, and the magnetic, crystal-structural characteristics of the soft magnetic layer are improved. Consequently, because the thickness of the soft magnetic layer is minimized while the magnetic properties thereof are improved, a medium noise generated by the soft magnetic layer is minimized, and the SNR is improved. The soft magnetic orientation layer can be made of Pt, Au, Ag, Pd, Co, Permalloy, or an alloy of at least two materials selected from these materials.

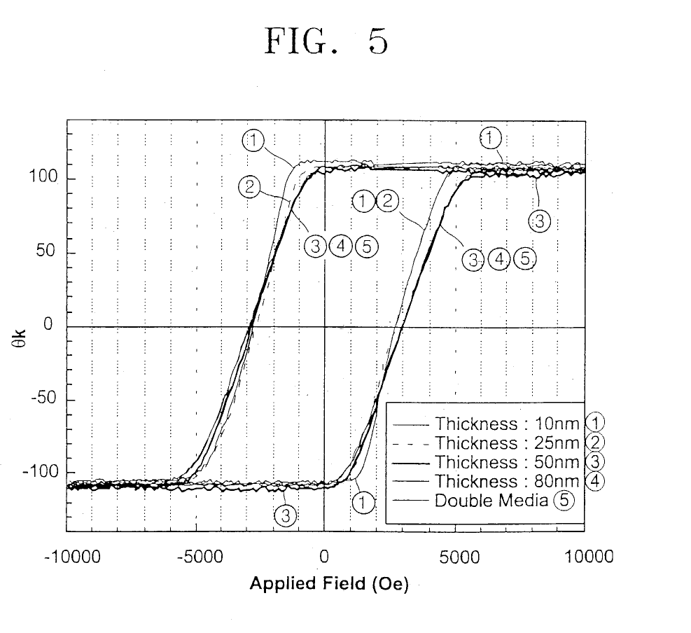

FIG. 5 shows the magnetic hysteresis loops of a perpendicular magnetic recording medium with a double magnetic recording layers according to the present invention, in which a soft magnetic orientation layer is deposited using Pt, and the magnetic hysteresis loops of a conventional perpendicular magnetic recording medium with a double magnetic layer.

Referring to FIG. 5, even when the thickness of a soft magnetic layer in the perpendicular magnetic recording medium according to the present invention is reduced to 50 nm, the perpendicular magnetic recording medium according to the present invention has the same magnetic properties as those of a conventional perpendicular magnetic recording medium with a double magnetic layer in which a soft magnetic layer (double media) is 300 nm thick. Thus, the reduction of the thickness of the soft magnetic layer to 50 nm enables to form a perpendicular magnetic recording medium with low noise.

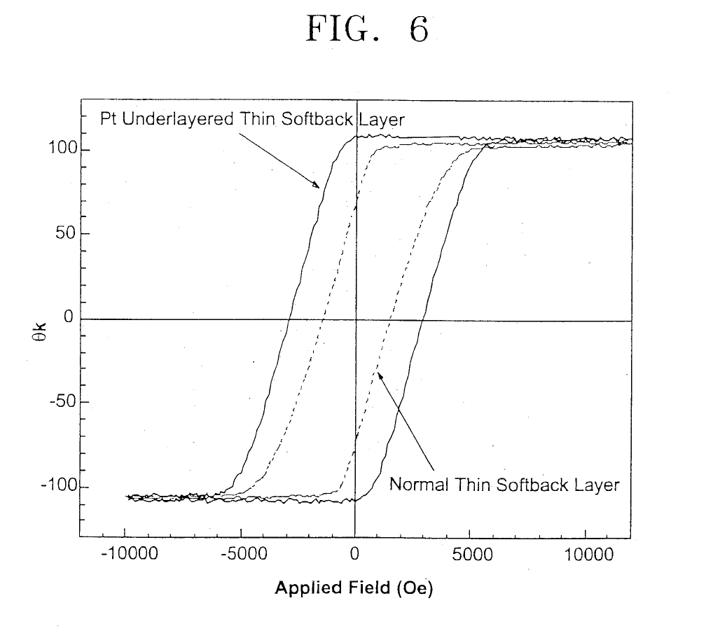

FIG. 6 shows the magnetic hysteresis loops of a perpendicular magnetic recording medium with a double magnetic layer according to the present invention, in which a 50 nm-thick soft magnetic layer is deposited using a Pt soft magnetic orientation layer, and the magnetic hysteresis loops of a normal perpendicular magnetic recording medium with a double magnetic recording layer, in which a 50 nm-thick soft magnetic layer is deposited without using a Pt soft magnetic orientation layer. As shown in FIG. 6, even if the soft magnetic layer becomes thinner, the perpendicular magnetic recording medium using the Pt soft magnetic orientation layer has improved magnetic properties than the perpendicular magnetic recording medium not using the Pt soft magnetic orientation layer.

As described above, in the present invention, a soft magnetic orientation layer for magnetically orienting a soft magnetic layer is positioned below the soft magnetic layer. Thus, although the soft magnetic layer is thin, it still has stable magnetic properties and generates less noise.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A perpendicular magnetic recording medium in which a perpendicular magnetic recording layer is placed over a substrate and a soft magnetic layer is placed between the substrate and the perpendicular magnetic recording layer, the perpendicular magnetic recording medium comprising:
a soft magnetic orientation layer placed between the soft magnetic layer and the substrate to magnetically and crystallographically orient the soft magnetic layer.

2. The perpendicular magnetic recording medium of claim 1, wherein a perpendicular orientation underlayer for perpendicularly orienting the magnetization of the perpendicular magnetic recording layer is placed between the perpendicular magnetic recording layer and the soft magnetic layer.

3. The perpendicular magnetic recording medium of claim 1, wherein the soft magnetic orientation layer is mainly formed of any of Pt, Au, Ag, Pd, Co, and Permalloy.

4. The perpendicular magnetic recording medium of claim 2, wherein the soft magnetic orientation layer is mainly formed of any of Pt, Au, Ag, Pd, Co, and Permalloy.
